(19) United States
(12) Patent Application Publication
(10) Pub. No.: US 2004/0119283 A1
(43) Pub. Date: Jun. 24, 2004

(54) Securing structure for end of hose with corrugated metal tube

(76) Inventor: Norihiko Furuta, Aichi-ken (JP)

Correspondence Address: Peter T. Holsen, ANDRUS, SCEALES, STARKE & SAWALL, LLP, Suite 1100, 100 East Wisconsin Avenue, Milwaukee, WI, 53202-4178, US

(21) Appl. No.: 10/625,310

(22) Filed: Jul. 23, 2003

(30) Foreign Application Priority Data
Jul. 24, 2002 (JP) 2002-215771

(51) Int. Cl. F16L 33/00

(52) U.S. Cl. 285/256

(57) ABSTRACT

A hose for conveying fluid comprises a corrugated metal tube and outer layer circumscribing the internal corrugated metal tube. A securing structure assembled on an end portion of a hone includes a socket fitting securely compressed or swaged to a hose body so as to extend longitudinally of the hose a distance beyond an insertion end of an insert pipe integral on a connecting part.

### BACKGROUND OF THE INVENTION

The present invention relates to a hose with corrugated metal tube, which is suitable for fuel conveying hose for automobiles, refrigerant conveying hose or any other fluid conveying hose, and more particularly to a securing structure assembled on an end portion thereof.

Typical rubber hoses, for example, made of blended product of acrylonitrile-butadiene rubber and polyvinyl chloride CBR/PVC blend) which is excellent in resistance to gasoline permeability, have been used for conveying fuel for automobiles or the like in view of their high vibration-absorbability, easy assembling or the like. However, for the purpose of global environment protection, the regulations have been recently tighten against permeation of fuel for automobiles or the like, and are anticipated to be further tighten in the future. Further, hoses are demanded to meet the requirements to convey highly permeable fluid such as hydrogen gas used in fuel cells or carbon dioxide (CO₂) refrigerant.

Then it is anticipated difficult to satisfy the future requirements with hoses made only of organic materials such as rubber or resin.

Accordingly, it is currently considered to adapt a hose with a corrugated metal tube as an inner layer because hose with corrugated metal tube is expected to have an extremely high fluid impermeability to meet the demand for a fluid impermeable hose.

As for a hose with corrugated metal tube, such hoses as disclosed in the following Document 1, Document 2 and Document 3 are known.

Document 1 JP, A, 2001-182872

Document 2 US20020007860A1

Document 3 JP, U, 51-150511

In case of the hose with corrugated metal tube, even if adapted for hydrogen gas of small molecular mass used for fuel cells, a corrugated metal tube in or as an inner layer reduces gas permeation zero, i.e., completely eliminates permeation of gas.

Up to now, as shown in FIG. 5, a securing structure for typical rubber hose is usually constructed as in following manner. A rigid metallic insert pipe 200 formed integrally on a connecting part 202 is inserted in a hose body 204. A socket fitting 206 including an inwardly directed collar-like portion 208 is then fitted onto the hose body 204. And then, the socket fitting 206 is securely compressed or swaged radially inwardly to the hose body 204. Thereby the hose body 204, along with the socket fitting 206, is fixedly secured to the connecting part 202, and a seal is provided on an end portion of a hose.

In a conventional securing structure for an end portion of the hose shown in FIG. 5, an axial length of the socket fitting 206 is designed so that an end thereof, namely a right-hand and thereof in FIG. 5 is located at a position generally corresponding to a right-hand end of the insert pipe 200 or toward left from a right-hand end thereof.

The reason is that if the socket fitting 206 extends long rightward beyond a right-hand end of the insert pipe 200, the hose body 204 might be depressed and deformed radially inwardly on a right-hand portion from the right-hand end of the insert pipe 200 by securely compressing or swaging the socket fitting 206 radially inwardly, and the radially inwardly deformed portion might block off a hollow portion of the insert pipe 202, namely a fluid passage way thereof, depending on the circumstances.

Here, as shown in FIG. 6(A), if the hose body 210 includes a corrugated metal tube 212, the hose body 210 is repeatedly vibrated or bent, or is repeatedly subject to pressure as shown in FIG. 6 (B), a stress is repeatedly concentrated between an end portion of the insert pipe 214 and the corrugated metal tube 212. Because the insert pipe 214 is rigid and inflexible although the corrugated metal tube 212 is flexible. And it causes a problem that the corrugated metal tube 210 is likely broken.

Once the corrugated metal tube 212 is broken in that way, a hose itself including the internal corrugated metal tube 212 looses a gas barrier property although other portions thereof are not damaged at all. In some cases, properties of the hose such as flexibility and vibration absorbability are

In the example shown in FIG. 6(A), the corrugated metal tube 212 is bonded to an end surface of the insert pipe 214 axially in end-to-end relation at an Cal end thereof by welding.

Specifically in this case, vibration, bending-deformation or flexural deformation of the hose is more likely to break the hose on an end-to-end weld-bonded portion.

The above are described with reference to a hose for conveying hydrogen gas used in a fuel cell as example. The similar problems are anticipated in common to any hoses. For example, it may be the case that a hose with corrugated metal tube is employed for conveying fuel gasoline for the purpose to deal with gasoline or the like permeating to an air or for high temperature and high pressure application due to high output power of equipment, where low permeation is severely regulated. Or it may be the case that a hose with corrugated metal tube is employed to convey carbon dioxide (CO₂) as refrigerant fluid, which is low in amount of particles just like hydrogen and has high gas permeation. Further, it may be any other case that a hose with corrugated metal tube is applied in fields under severe regulations against gas permeation.

It is an object of the present invention to provide a securing structure assembled on an end portion of a hose with corrugated metal tube to settle the problems described above.

### SUMMARY OF THE INVENTION

According to the present invention, there is provided a novel securing structure assembled on an end portion of a hose with corrugated metal tube for securing a hose body to a connecting part. This securing structure comprises a hose body having a corrugated metal tube as an inner layer and outer layer circumscribing a radial outer side thereof. The securing structure further comprises a connecting part and a rigid insert pipe. The connecting part is arranged on an end portion of a hose. The rigid insert pipe is provided on the connecting part, and is inserted in an axial end portion of the hose body and secured to an end portion of the corrugated metal tube. The securing structure also comprises a socket fitting fitted on an end portion of the hose body. The socket fitting is securely compressed or swaged radially inwardly to be secured to an end portion of the hose body in which the insert pipe is inserted. Also the socket fitting extends longitudinally of the hose beyond an inserting end of the insert pipe in a direction away from an end of the hose body.

According to the present invention, even if a hose is repeatedly vibrated, banding-deformed or flexurally deformed, or a hose is repeatedly internally subject to pressure by fluid travelling therein, a stress is effectively prevented from concentrating repeatedly between an inserting end of the insert pipe and the corrugated metal tube, under restraining or arresting force imposed from outside by the socket fitting which extends long or relatively long. The corrugated metal tube is thereby effectively prevented from being damaged or broken, for example, at a portion connected to the insert pipe.

In one embodiment of the present invention, a socket fitting is preferably designed so as to extend at least 5 mm, more preferably at least 10 mm beyond an inserting end of the insert pipe.

The insert pipe may be provided integrally on the connecting part.

Now, the preferred embodiments of the present invention will be described in detail with reference to the drawings.

### BRIEF DESCRIPTION OF THE DRAWINGS

FIG. 1 is a perspective view showing a construction of a hose with corrugated metal tube.

FIG. 2 is a cross-sectional view showing a securing structure of the hose with corrugated metal tube according to the present invention.

FIG. 3(A) is a cross-sectional view showing another securing structure according to the present invention.

FIG. 3(A) is a fragmentary aged view showing a relevant part of another securing structure according to the present invention.

FIG. 4 is a cross-sectional view showing yet another securing structure according to the present invention.

FIG. 5 is a cross-sectional view showing an example of a securing structure assembled on an end portion of a hose including no inner corrugated metal tube.

FIG. 6(A) is a descriptive view showing a problem involved in a conventional hose including internal corrugated metal tube.

FIG. 6(B) is a view showing vibration mode of an end portion of the hose including corrugated metal tube.

### DETAILED DESCRIPTIONS OF PREFERRED EMBODIMENTS

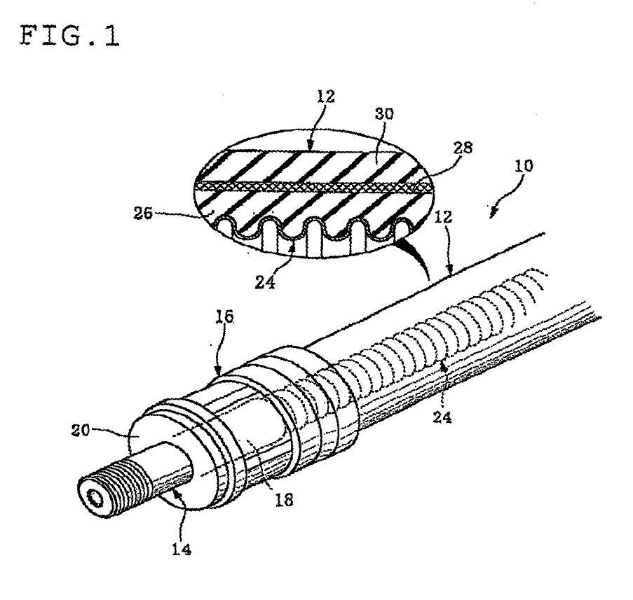

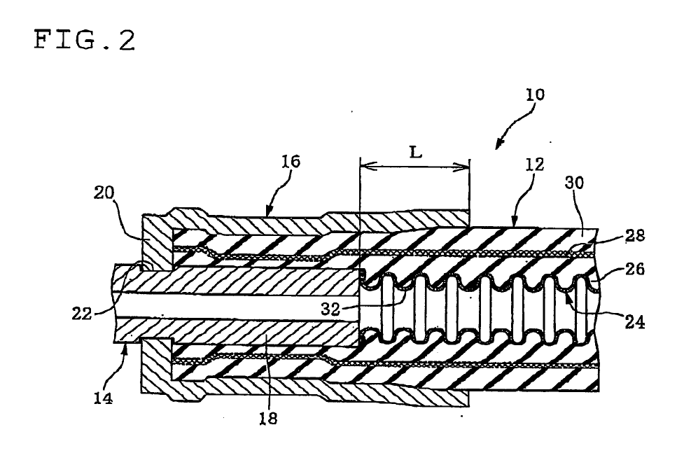

In FIGS. 1 and 2, a numeral reference 10 indicates a hose with corrugated metal tube (hereinafter referred to as a hose) which is preferably adapted for hydrogen or hydrogen gas conveying hose, refrigerant conveying hose for air conditioners, automobile fuel conveying hose or the like. A numeral reference 12 indicates a hose body, a numeral reference 14 a metallic connecting part fixed to the hose body 12, a numeral reference 16 a metallic socket fitting fitted onto or on an outer surface of the hose body 12. The socket fitting 16 is securely compressed or swaged radially inwardly and thereby the connecting part 14 is, along with the socket fitting 16, fixedly secured to an end portion of the hose body 12.

As shown in FIG. 2, the connecting part 14 is formed integrally with a rigid insert pipe 18. The socket fitting 16 is securely compressed or swaged to the hose body 12 in which the insert pipe 18 is inserted and thereby the hose body 12 is fixedly secured to the insert pipe 18 and the socket fitting 16 at an end portion of the hose body 12 while the end portion of the hose body 12 is clamped by the socket fitting 16 and the insert pipe 18 both from radially outside and inside.

That is, an end portion of the hose body 12 is fixedly secured to the connecting part 14.

The socket fitting 16 has a sleeve and a radially inwardly directed collar-like portion 20 on an axial end thereof, and the connecting part 14 is formed with an annular fit-engagement groove 22 at an axial position corresponding to the collar-like portion 20 on a radially outer surface thereof. An inner end portion of the collar-like portion 20 fits in the fit-engagement groove 22 in engagement relation while the socket fitting 16 is securely compressed or swaged to the hose body 12.

The hose body 12 has a corrugated metal tube 24 as an innermost layer and multi-layers, an inner elastic layer 26, a reinforced layer 28 as an intermediate layer and an outer elastic layer 30 which circumscribe an outer side of the corrugated metal tube 24. The reinforced layer 28 also has certain elasticy. Each of the layers is fixedly bonded in unitary relation to an adjacent layer into a composite hose by vulcanizing or other manner.

In this embodiment, the inner elastic layer 26, the reinforced layer 28 and the outer elastic layer 30 construct outer layer circumscribing the corrugated metal tube 24.

The reinforced layer 28 may be a wire-reinforced layer or a fiber-reinforced layer.

And the inner elastic layer 26 may be made of rubber or resin having elasticity while the outer elastic layer 30 may be a layer made of rubber.

On the other hand, the corrugated metal tube 24 as an innermost lay er is formed with corrugations 32 for generally entire axial length thereof, which provides the corrugated metal tube 24 with flexibility.

That is, although, in this embodiment, an innermost layer of the hose 10 includes a metal tube, the hose 10 is provided entirely with flexibility, thanks to the corrugations 32 formed on the metal tube.

The corrugated metal tube 24 may be made of materials such as steel products including stainless steel, copper, copper alloy, aluminum, aluminum alloy, nickel, nickel alloy, titanium or titanium alloy, and preferably may be made of stainless steel.

A wall thickness of the corrugated metal tube 24 may be from 20 to 500 μm, preferably is minimum 50 μm in view of preventing defects such as pinholes and further in view of processing of the corrugations 32 or the like, and minimum 300 μm in view of flexibility and durability.

In this embodiment, the corrugated metal tube 24 is bonded and secured to an insertion end or insertion side end of the insert pipe 18 at an axial end thereof along the entire circumference thereof by welding.

The socket fitting 36 or the sleeve of the socket fitting 16 extends longitudinally of the hose 10 a distance L rightward or in a direction away from an end of the hose body 12 from an inserting end of the insert pipe 18 with respect to the hose body 12, i.e., from the righthand end thereof as seen in FIG. 2.

That means, as seen in FIG. 2, an end or right-hand end of the socket fitting 16 is located a distance L in an inserting direction or rightward away from an end or right-hand end of the insert pipe 18.

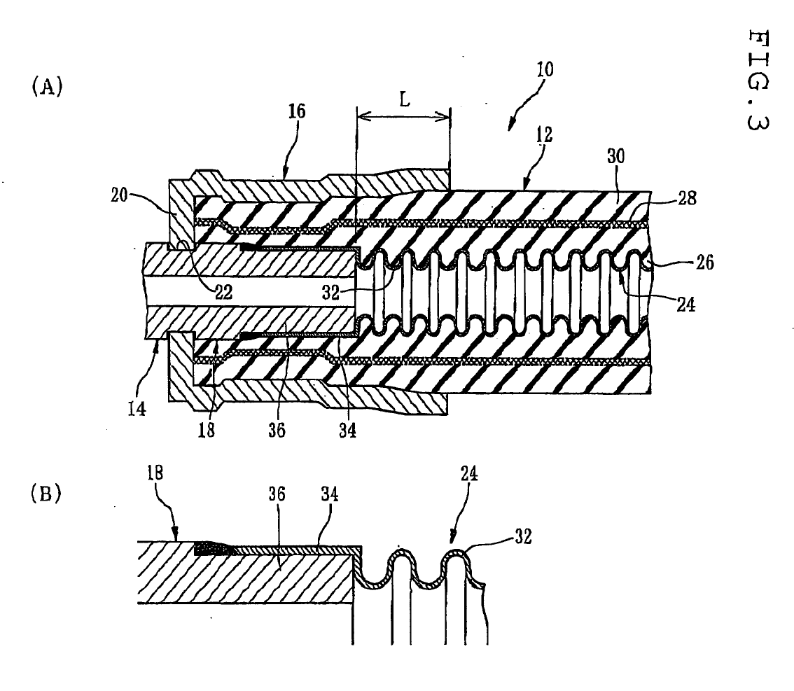

FIG. 3(A) shows another embodiment according to the present invention.

In this embodiment, a non-corrugated, Anally straight-walled portion or straight pipe portion 34 is formed on an axial end side of the corrugated metal tube 24. As shown in detail in FIG. 3(B), a fit-in portion 36 of the insert pipe 18 is fitted in the straight-walled portion 34, and then in this state a tip end portion of the straight-walled portion 34 is fixedly bonded to the insert pipe 18 by welding.

Also in this embodiment, the socket fitting 16 extends a distance L in an inserting direction or rightward from an end or right-hand end of the insert pipe 18 as shown in FIG. 3(A).

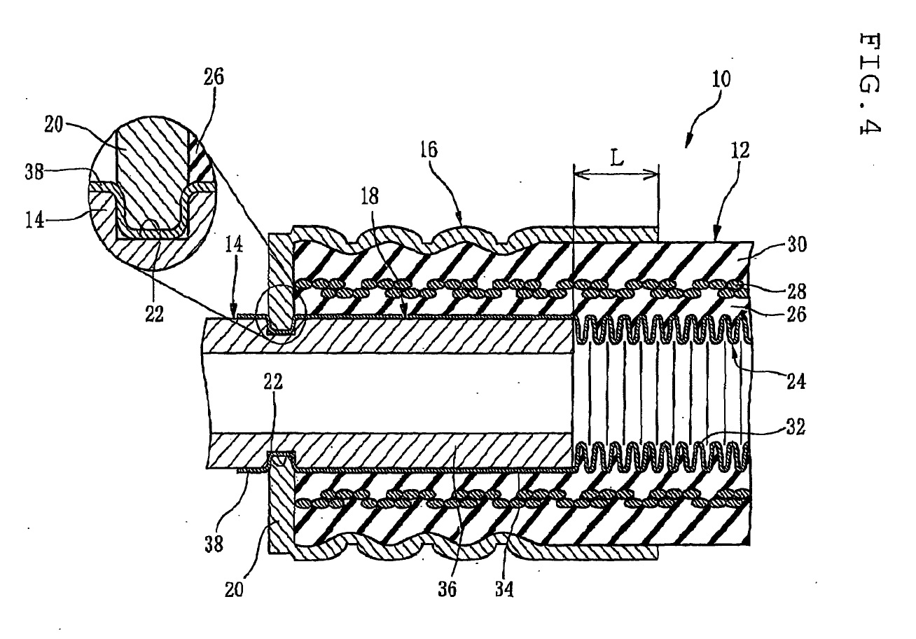

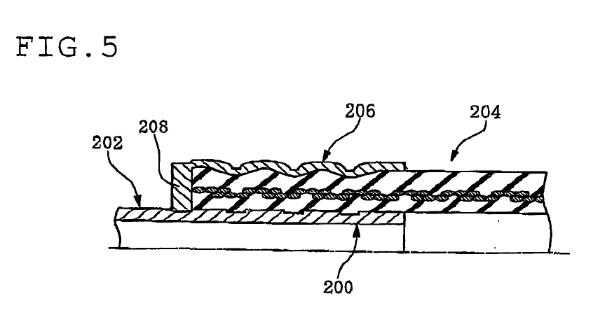

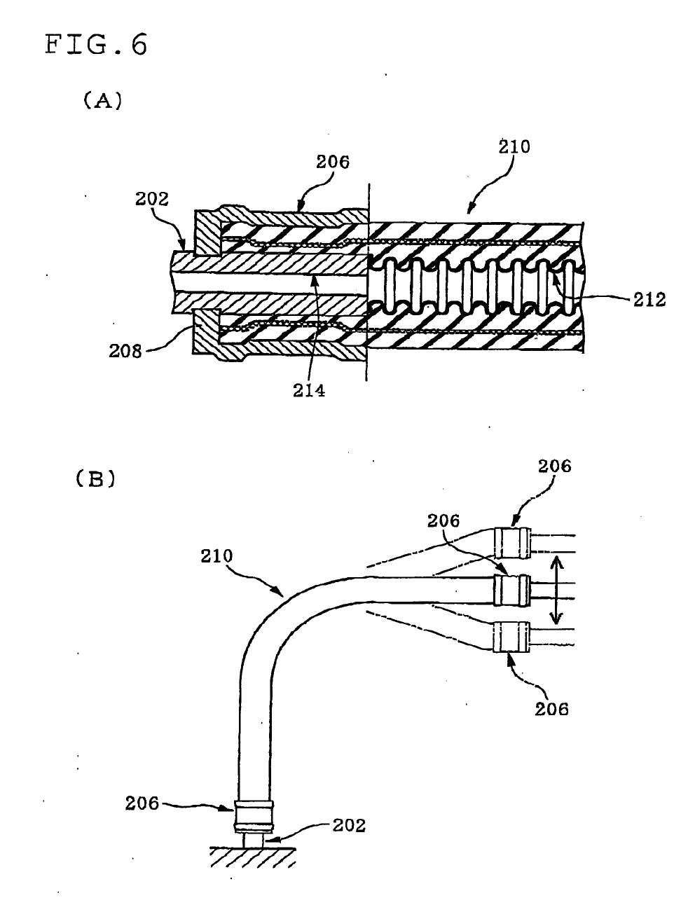

FIG. 4 shows a yet another embodiment according to the present invention.

Referring to FIG. 4, a leading end portion of the straight-walled portion 34 of the corrugated metal tube 24 is configured au an extending portion 38 to extend axially so as to be exposed out of outer layer. The extending portion 38 is clamped in between the collar-like portion 20 and the fit-engagement groove 22 by securely compressing or swaging the socket fitting 16. The corrugated metal tube 24 is thereby fixedly secured to the insert pipe 18, i.e., to the connecting part 14, and at the same time a seal is provided between the insert pipe 18 and the corrugated metal tube 24.

According to an end portion securing structure of the hose 10 in the embodiment as shown in FIGS. 1 and 2, even if the hose 10 is repeatedly subject to vibration, bending-deformation or internal pressure by fluid travelling therein, it is favorably prevented that a stress is repeatedly concentrated on the corrugated metal tube 24 at an inserting end portion or an end portion of an insertion side of the insert pipe 18 as restraining or arresting force is provided from outside by the socket fitting 16 which extends long or relatively long. Accordingly, the corrugated metal tube 24 is effectively prevented from being damaged or broken resulted from the stress concentration thereon.

And, as shown in FIG. 3, a securing structure of a hose may be constructed as follows The straight-walled portion 34 is formed on the corrugated metal tube 24, the insert pipe 18 is inserted for a desired length in the straight-walled portion 34 and a tip end portion thereof is weld-bonded to the insert pipe 18. Even in this case, if the hose body 12 is repeatedly subjected to vibration, bending-deformation or flexural deformation there is a fear that a stress is concentrated repeatedly on the corrugated metal tube 24 at or near a tip end of the insert pipe 18 unless the socket fitting 16 is formed long or relatively long. In the embodiment shown in FIG. 3, as in the aforementioned embodiment, the socket fitting 16 extends long or relatively long beyond an end of the insert pipe 18. Since this construction restricts the hose body 12 including the corrugated metal tube 24 from being bent, deformed, bending-deformed or flexurally deformed in vibrating direction or in a direction perpendicular to an am within the socket fitting 16 or a portion inside of the socket fitting 16, a stress is effectively limited to concentrate between a tip end or a tip end position of the insert pipe 18 and the corrugated metal tube 24.

Further, as shown in FIG. 4, even if the corrugated metal tube 24 and the insert pipe 18 are bonded together not by welding, there is a fear that a stress is concentrated between a tip end or tip end position of the insert pipe 18 and the corrugated metal tube 24 unless the socket fitting 16 is formed long or relatively long. In the embodiment of FIG. 4, since the socket fitting 16 is formed a distance L rightward apart from right-hand end of the insert pipe 18 as shown in FIG. 4, a stress is effectively limited to concentrate therebetween just as in the aforementioned embodiments.

Although the preferred embodiments have been described above, these are only some of embodiments of the present invention.

For example, although the insert pipe 18 is formed integrally on the connecting part 14 in the above embodiments, the insert pipe 18 may be provided separately from the connecting part 14. Moreover, the present invention may be adapted for various type of fluid conveying hose, other than the ones as in the above embodiments. Such variations are intended to be within the scope of the present invention and the following claims.

We claim:

1. A securing structure assembled on an end portion of a hose with corrugated metal tube for securing a hose body to a connecting part, comprising:
a hose body having a corrugated metal tube as an inner layer and an outer layer circumscribing a radial outer side thereof,
a connecting part arranged on an end portion of a hose,
a rigid insert pipe provided on the connecting part, the rigid insert pipe being inserted in an axial end portion of the hose body and secured to an end portion of the corrugated metal tube, and
a socket fitting fitted on an and portion of the hose body, securely compressed or swaged radially inwardly to be secured to an end portion of the hose body in which the insert pipe is inserted, the socket fitting extending longitudinally of the hose beyond an inserting end of the insert pipe in a direction away from an end of the hose body.

2. A securing structure as set forth in claim 1, wherein the rigid insert pipe is formed integrally on the connecting part.
